(19) United States
(12) Patent Application Publication
(10) Pub. No.: US 2006/0136441 A1
(43) Pub. Date: Jun. 22, 2006

(54) Method and apparatus for synchronous project collaboration

(76) Inventor: Tetsunosuke Fujisaki, Armonk, NY (US)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 10/509,904

(22) PCT Filed: Mar. 31, 2003
(86) PCT No.: PCT/US03/09876

§ 371 Date: Sep. 29, 2004

Related U.S. Application Data
(60) Provisional application No. 60/369,711, filed on Apr. 2, 2002.

(51) Int. Cl. G06F 17/00

(52) U.S. Cl. 707/101

(57) ABSTRACT

A disclosed project management system allows one or more team members to share documents in asynchronous and synchronous collaboration modes. A synchronous collaboration system is provided as an incremental addition that extends a conventional asynchronous collaboration system. One or more users can transition between asynchronous and synchronous collaboration modes. A plurality of users can interact in a synchronous collaboration mode to create and modify documents and perform other project tasks without requiring a token. A serializer initially receives each of the change requests and serializes them. The serialized requests are then sent to a broadcaster that broadcasts the requests to all users. Each user implements the broadcast change requests to the document as they are received so that shared documents are presented to each user in the same way at any given time.

### CROSS REFERENCE TO RELATED APPLICATIONS

This application claims the benefit of U.S. Provisional Application No. 60/369,711, filed Apr. 2, 2002.

### FIELD OF THE INVENTION

The present invention relates generally to project management systems and, more particularly, to protect management systems that facilitate the synchronous interaction of a number of individuals to create and modify documents and to perform other project tasks.

### BACKGROUND OF THE INVENTION

Project management systems increase productivity and efficiency of members of a project team by automating the flow of information, including documents and files, among team members. Project management systems are often deployed to support collaborative work among a group of individuals, such as the members of a project team. Asynchronous collaboration systems allow team members to collaborate on one or more project tasks independently in time or space. Synchronous collaboration systems, on the other hand, allow team members to simultaneously collaborate on one or more project tasks in the same or a different location.

As the employees of an enterprise become more distributed in time and place, for example, due to flexible work hours, globalization and the distribution of enterprise employees to avoid the destruction of a centralized enterprise location, it becomes even more important to provide team members with an effective tool for asynchronous and synchronous collaboration. In today's enterprise environment, it is important for a project management system to permit distributed team members to initiate ad-hoc virtual meetings, for example, over the Internet. Generally, such project management systems must allow distributed team members to communicate and interact as if the team members were in the same place.

When team members collaborate, they often share and revise documents, such as tables, charts and drawings. Often, the various requested revisions from team members on a particular document may cause a conflict. For instance, one team member may initiate a command to move a particular object to the left, while another team member may initiate a command to move the same object to the right. Even when such conflicting commands occur close in time, however, the team members should see the document in the same way as the results of all of the changes made from the entire team.

Most document management systems prevent conflicting changes from multiple team members by employing a “token.” One or more tokens are associated with each shared document. If a team member desires to make a revision to a document, the team member must first obtain the appropriate token(s). Once the team member has obtained the token(s) and made the desired revisions, the token should be released and returned to a token pool. If one team member has the token, then all other team members must wait to make any further revisions to the associated document (or document portion). In this manner, the document management system can safely serialize revisions and ensure that different team members do not make conflicting revisions to shared documents.

Such token-based mechanisms, however, introduce a delay before a team member can make a revision, as the team member must first obtain the token before performing most actions on the shared document. This is especially true when the token is stored at a central server, which is often the case. In addition, when one team member has possession of the token, all other team members are unable to manipulate the document. Finally, if the computer of the team member currently with possession of the token happens to crash, then the entire system is locked-up for at least a minimum time-out period.

A need therefore exists for an improved project management system and method that facilitate the synchronous and asynchronous interaction of a number of individuals to create and modify documents and other project tasks. A need also exists for an improved project management system and method that incrementally provides a synchronous collaboration system to extend a network asynchronous collaboration system so that one or more users may transition between asynchronous and synchronous collaboration modes. A further need exists for a mechanism that determines a canonical ordering of conflicting change requests in a shared document without first requiring the user to obtain token. Yet another need exists for a method and apparatus for presenting shared documents to each team member in the same way at any given time.

### SUMMARY OF THE INVENTION

The present invention provides a project management system that allows one or more team members to work on a project. Generally, a method and apparatus are provided for peer-to-peer sharing of documents in asynchronous and synchronous collaboration modes. The present invention allows documents to be revised by individual team members in an asynchronous collaboration mode or as the result of group meetings (in or more locations) by multiple team members in a synchronous collaboration mode. According to one aspect of the invention, a synchronous collaboration system is provided as an incremental addition that extends a conventional asynchronous collaboration system. In this manner, the present invention allows one or more users to easily transition between asynchronous and synchronous collaboration modes.

According to another aspect of the present invention, a plurality of users can interact in a synchronous collaboration mode to create and modify documents and perform other project tasks without requiring a token. Each user can submit potentially conflicting change requests for an object spontaneously and concurrently. For example, a first user might request that an object is moved to the left while another user might request that the same object is moved to the right. A serializer initially receives each of the change requests and serializes them, for example, based on an arrival time or a global time stamp. The serialized requests are then sent in order to a broadcaster that broadcasts the requests to all users. For example, the change requests can be broadcast to all currently active users in real-time and can be stored in a database for subsequent access by other users. Each user implements the broadcast change requests to the document as they are received so that shared documents are presented to each user in the same way at any given time.

A more complete understanding of the present invention, as well as further features and advantages of the present invention, will be obtained by reference to the following detailed description and drawings.

### BRIEF DESCRIPTION OF THE DRAWINGS

FIG. 1 illustrates a relationship between a project and its constituent tasks in the context of the present invention;

FIG. 2 illustrates an exemplary record in a project property list which may define properties of the project shown in FIG. 1;

FIG. 3 illustrates an exemplary record in a task property list which may define properties of a task shown in FIG. 1;

FIG. 4 illustrates a network environment in which the present invention can operate;

FIG. 5 illustrates a configuration of the project management system of FIG. 4 in an asynchronous collaboration mode;

FIG. 6 illustrates a configuration of the project management system of FIG. 4 in a synchronous collaboration mode;

FIG. 7 is a flow chart illustrating an exemplary implementation of a transition process that allows one or more team members to transition between asynchronous and synchronous collaboration modes in accordance with the present invention;

FIG. 8 is a flow chart illustrating an exemplary implementation of a task completion process incorporating features of the present invention;

FIG. 9 illustrates the operation of the sound board of FIG. 6 in further detail;

FIG. 10 is a flow chart illustrating an exemplary implementation of a conventional token-based document management system;

FIG. 11 is a flow chart illustrating an exemplary implementation of a shared document revision process incorporating features of the present invention;

FIG. 12 illustrates a document that is modified in accordance with the present invention; and

FIGS. 13 through 15 illustrate a number of illustrative applications of the present invention.

### DETAILED DESCRIPTION

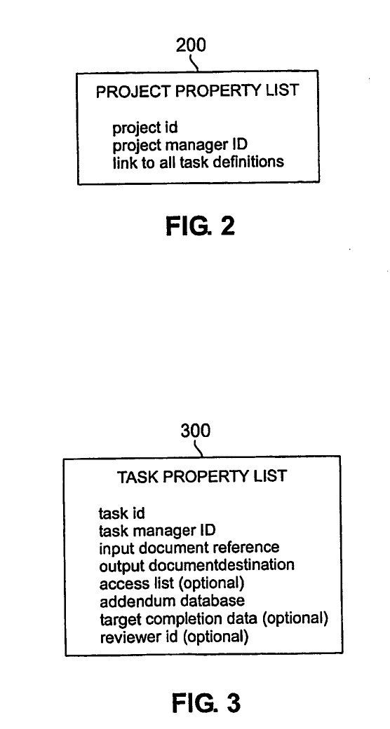

As discussed further below in conjunction with FIG. 2, a project 100 is defined by a project property list 200 and comprises one or more connected tasks, such as the tasks 150-1, 150-2. As used herein, a project 100 is an activity that generates one or more output documents 140 from one or more input documents 110, and may also produce one or more intermediate documents 120. A project 100 comprises one or more meetings among one or more team members and documents associated with the project or meetings. The present project management system allows the current version of each document to be shared among each authorized member of a project team.

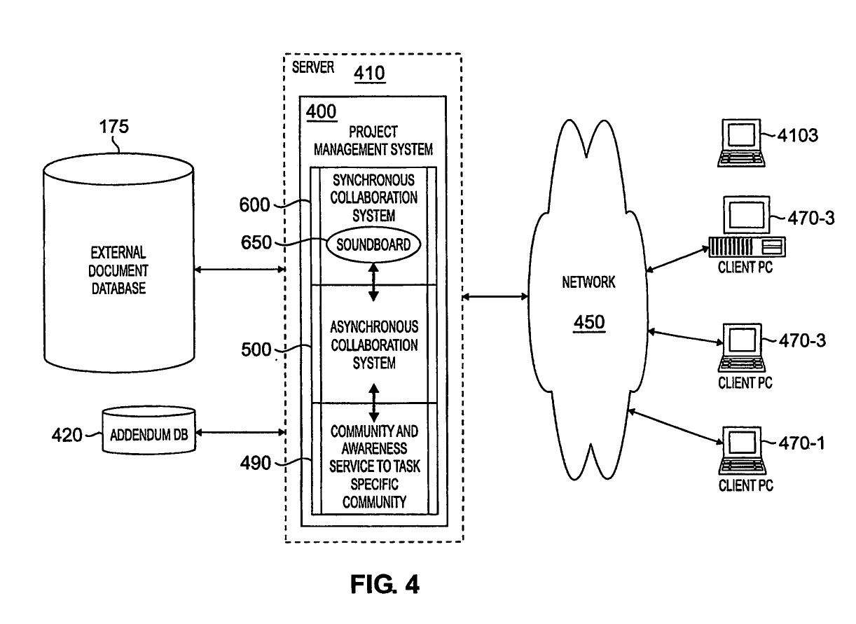

As discussed further below in conjunction with FIG. 3, each task 150 is defined by a task property list 300 and comprises one or more defined document derivations. A task 150 is defined as a process to derive one or more output documents 140 or one or more intermediate documents 120 from one or more input documents 110 or intermediate documents 120.

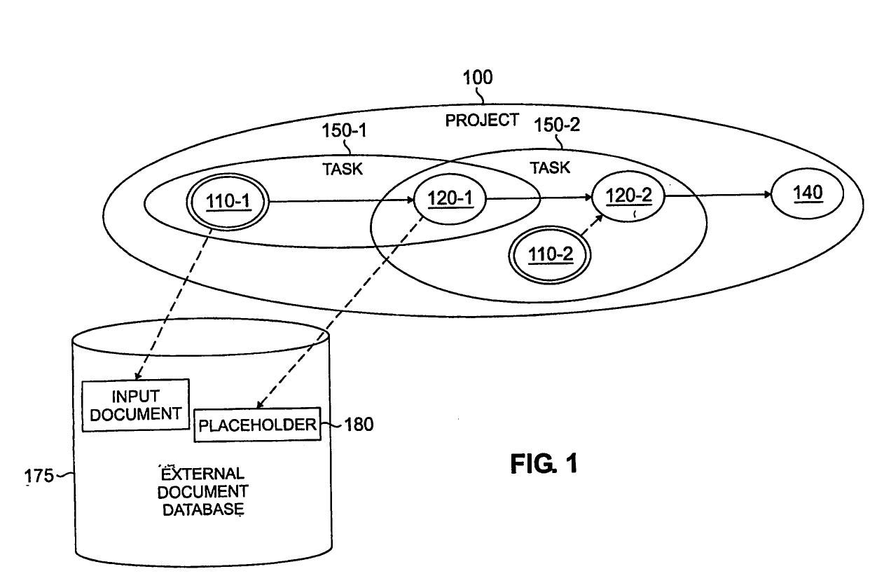

The input, intermediate and output documents 110, 120 and 140 may be stored, for example, in an external document database 175. The external document database 2000 may be embodied as any commercially available document system. Documents that do not yet exist are represented in FIG. 1 using placeholders 180 that are stored in the document database 175. A given task 150 is said to be active when all input documents 110 exist and the output documents 140 have not yet been generated. When a task 150 is active, an associated task manager is responsible for generating an output document 140 and to replace the placeholder 180 in the external document database 175 with a real document. Generally, when the output document 140 of the task 150 is generated and stored in the document source database 175, the next task will become active.

As previously indicated, a project 100 is defined by a project property list 200. FIG. 2 illustrates an exemplary record in a project property list 200 that may define properties of the project 100 shown in FIG. 1. In the illustrative embodiment, the project property list 200 includes, for example, a project identifier, a project manager identifier and one or more links to constituent task definitions, to record to the corresponding information associated with the project 100. The project identifier is the name of the project. The project manger identifier designates the person in charge of executing and completing the project. The links to constituent task definitions point to the appropriate task property lists 300.

As previously indicated, a task 150 is defined by a task property list 300. FIG. 3 illustrates an exemplary record in a task property list 300 that may define properties of a task 120 shown in FIG. 1. In the illustrative embodiment, the task property list 300 includes, for example, a task identifier, a task manager identifier, one or more of input document references, one or more of output document references, an optional access list, an addendum database reference, an optional target completion date, and one or more of optional reviewer identifiers. The task identifier is the name of the task. The task manger identifier designates the person in charge of executing and completing the associated task.

The input document references refer to the input documents 110 that are used in execution of the task 150. A task 150 becomes active when all input documents 110 exist. The output document destination refers to a placeholder document 180 or an existing document 110, 120. After the task completes, the output document destination should refer to an existing document 140. The optional access list designates additional individuals who will share responsibility with the task manager for completing the associated task. The task manager and the project manager can add names of individuals to participate in the execution of the associated task 150. The task manager, the project manager and the other identified individuals form a team. The people in the team are referred to herein as team members.

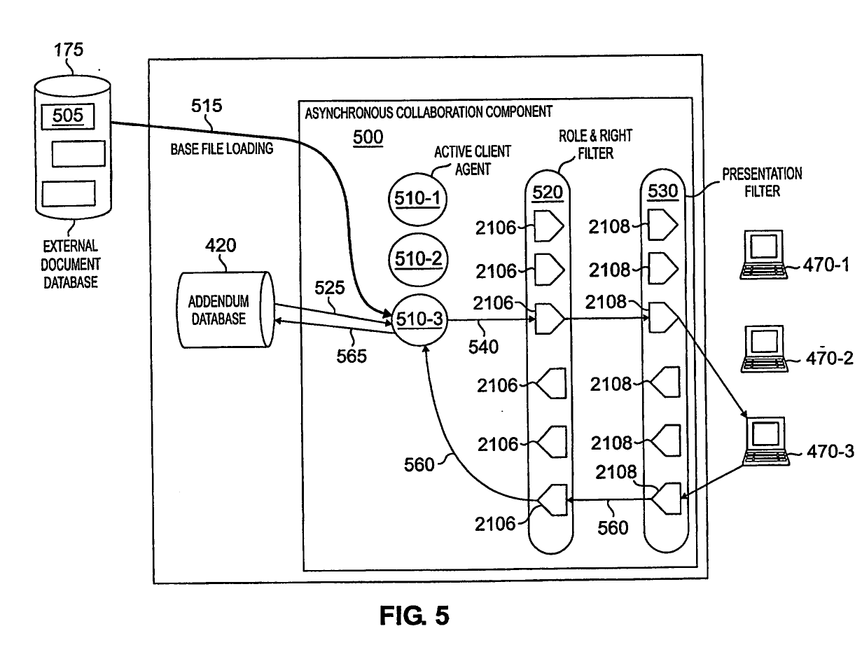

According to one aspect of the present invention, an addendum database 420 (shown, e.g., in FIG. 4) is a storage queue of events given by community personnel during the execution of the task 150. Thus, the task property list 300 includes a pointer to the addendum database 420 associated with the task 150. Events comprise, for example, change requests, comments, new ideas, overlays or modifications to the input document 110. Generally, the task manager must generate output documents 140 reflecting all comments, change requests, and other events accumulated in the persistent addendum database 420. The addendum database 420 records all events that have occurred during the task execution. A record in the addendum database 420 includes the details of the event, such as the person that caused the event, a timestamp, and other information. In this manner, the present invention allows a project to be restored to any point of project execution and to determine which person made a particular change at a particular time.

As shown in FIG. 3, the task property list 300 also includes an optional target completion date indicating an estimated date and time when the task 150 will be complete. The target completion date is monitored by the project management system 200. The target completion date supports alerts and warning reports to managers to keep the task 150 on schedule. The optional reviewer identifier in the task property list 300 launches an automatic approval process by designated reviewers when a task manager indicates that the task is complete.

FIG. 4 illustrates a network environment 450 in which the present invention can operate. As shown in FIG. 4, a project management system 400 in accordance with the present invention can be implemented, for example, on a server 410. The network 450 may be embodied, for example, as any wired or wireless network including the Public Switched Telephone Network (PSTN) and the Internet, or any combination of the foregoing. The network 450 allows one or more remote users to optionally participate, for example, by means of a connection to a local area network, a wide area network, the Internet or a combination of the foregoing.

The project management system 400 can accommodate multiple instances of a project 100. The project 100 will have a persistent life in the server 410. In other words, a project 100 will be maintained in the server 410 or in a related support system until deleted. The project management system 400 interacts with the external document database 175 to obtain, update and record the various input, intermediate and output documents 110, 120 and 140 associated with a given task 150. The members of a project team, each employing one or more client terminals 470-1 through 470-N (hereinafter, collectively referred to as client terminals 470), may communicate with one another and the project management system 400 over the network 450. Each client terminal 470 employs one or more client software applications (not shown) in order to perform one or more tasks 150.

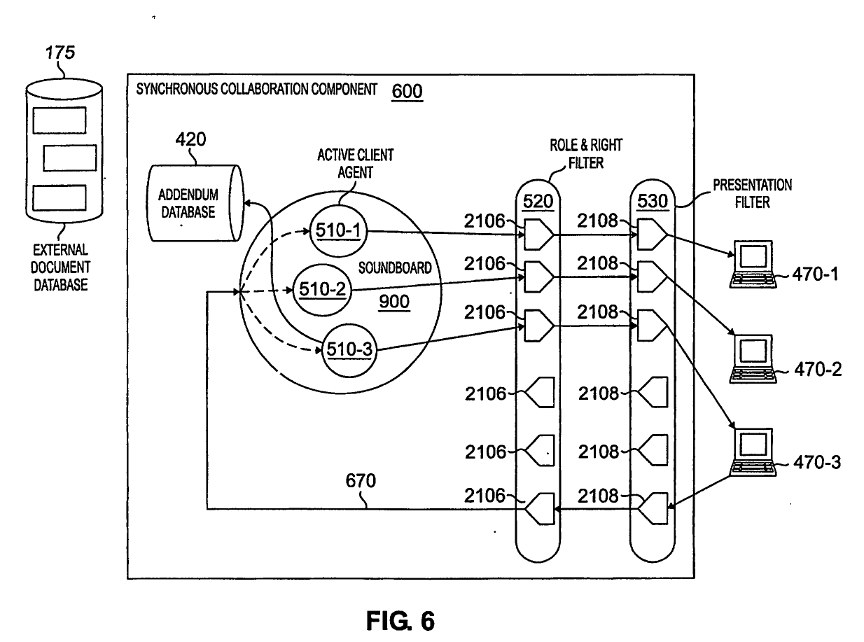

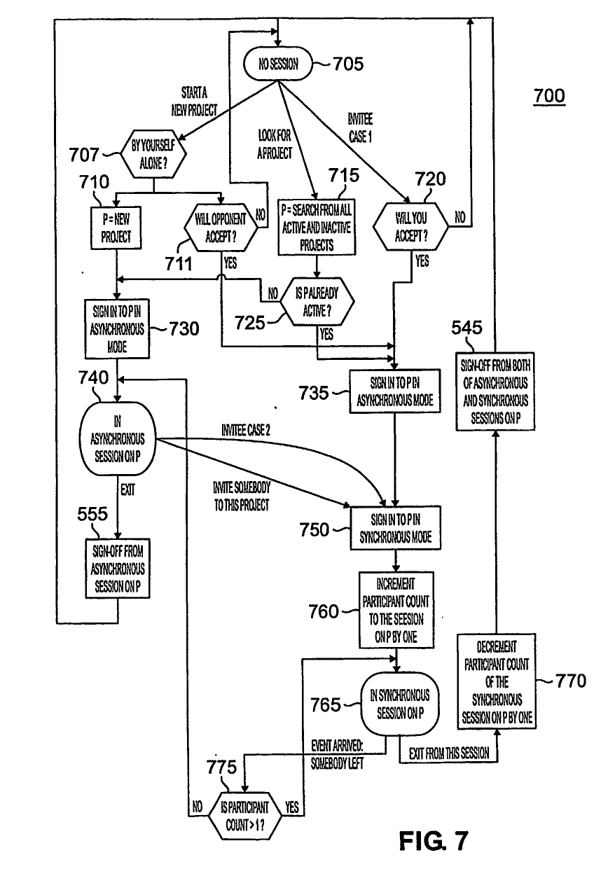

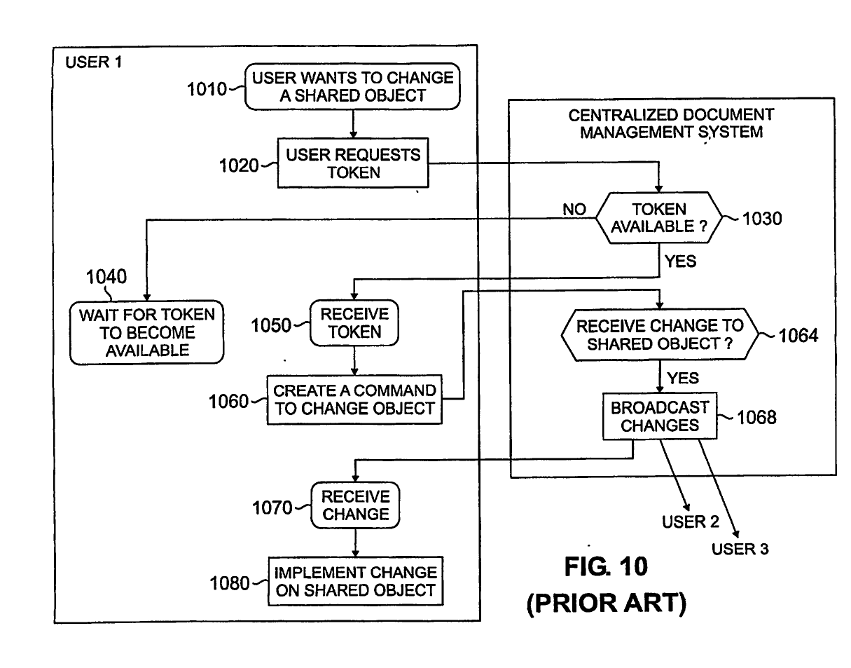

As shown in FIG. 4, a project management system 400 in accordance with the present invention includes an asynchronous collaboration component 500, discussed below in conjunction with FIG. 5, a synchronous collaboration component 600, discussed below in conjunction with FIG. 6, and a community and awareness service system 490. Generally, the asynchronous collaboration component 500 allows team members to see current task documents as the combination of the original input document 110 and associated updates from the addendum database 420. The synchronous collaboration component 600 allows two or more team member to participate in a collaborative session. As discussed further below in conjunction with FIG. 6, the synchronous collaboration component 600 expands the functions of the asynchronous collaboration component 500 with the addition of a sound board 900, as discussed further below in conjunction with FIG. 9. Generally, the sound board 900 makes actions by one team member visible to another team member.

According to one aspect of the present invention, the synchronous collaboration component 600 is an incremental addition to the asynchronous collaboration component 500. Thus, the present invention allows one or more team members to switch between asynchronous and synchronous collaboration modes. The community and awareness support system 490 has links to the asynchronous collaboration component 500 and the synchronous collaboration component 600. The community and awareness support system 490 monitors all events in the asynchronous collaboration component 500 and synchronous collaboration component 600 and notifies team members of appropriate events. The community service and awareness system 490 uses the access list in the task property 300 so that each task 150 in a project can have a different community.

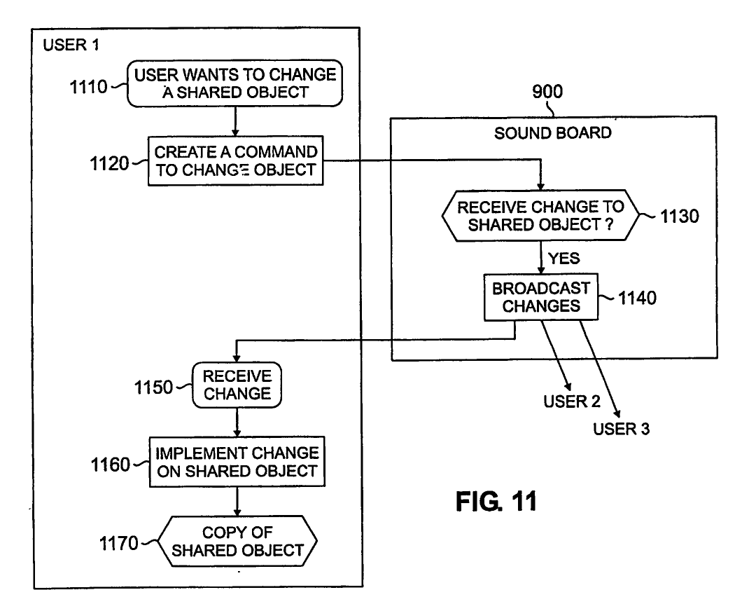

FIG. 5 illustrates a configuration of the project management system 400 of FIG. 4 in an asynchronous collaboration mode. As previously indicated, the asynchronous collaboration component 500 allows team members to see current task documents. At any point in time, a given document is comprised of a base document from the external document database 175 and the contributions kept in the task addendum database 420. The task addendum database 420 contains all the markups and other changes made by any team member. By overlaying the base document with the contributions in the task addendum database 420, team members can see the up-to-date status of the document, in a manner described further below in conjunction with FIG. 10.

As shown in FIG. 5, the asynchronous collaboration component 500 includes an active client agent 510 for each active team member. It is noted that in an asynchronous collaboration mode only one team member is active at a time. The active client agent 510 accesses the input documents in the document database 175 and any corresponding modifications contained in the addendum database 420 for delivery to the client software 480 on the client terminal 470 of the requesting team member. Information from the addendum database 420 contains data and commands for the client application software (not shown) to support replay of event sequences made by other team members up to a given point in time. All records in the addendum database 420 are time-stamped and tagged with additional information.

The active client agent 510 can transform the output, for example, in an XML format. The XML output will be delivered from the active client agent 510 to the client 470 via filters 520 and 530. The role and right filter 520 verifies the access rights of the team member for the information to be delivered. The present invention permits asymmetric assignment of roles (permitted actions) among team members. The role and right filter 520 examines each action and the data being exchanged to or from the action agent in terms of roles and capabilities. For instance, a team member with a low privilege level can read a document but cannot make contributions or changes. In this case, the role and right filter 520 will prevent any attempted changes by the low privilege team member from being recorded in the addendum database 420.

The presentation filter 530 transforms the information into an appropriate presentation, based on, for example, the role and access rights of the requester, as well as the properties of the computing and network environments. For example, based on the restrictions of the devices, communication channels and user's settings, the presentation filter 530 transforms the XML code to optimize transmission speed. The presentation filter 530 can also monitor cached image files in client machines 470 to minimize image transmission.

As shown in FIG. 5, an active client agent 510 associated with a particular team member, such as the active client agent 510-3 associated with the team member employing client terminal 470-3, will obtain a requested document from the document database 175 (as updated by any modifications in the addendum database 420) for presentation to the requesting team member, and will record any further authorized modifications to the document in the addendum database 420. The requested document 505 will be accessed by the active client agent 510-3 along a path 515, together with any associated updates to the requested document 505 from the addendum database 420 along a path 525, and passed to the requesting team member along a path 540 through the role and right filter 520 (provided that the requesting team member has the appropriate access privileges). Similarly, any authorized changes to the requested document (e.g., additions or change requests, or both) that are made by the requesting team member are received by the active client agent 510 along a path 560 through the role and right filter 520 (provided that the requesting team member has the appropriate modification privileges), for recording in the addendum database 420 along a path 565.

FIG. 6 illustrates a configuration of the project management system 400 of FIG. 4 in a synchronous collaboration mode. The synchronous collaboration component 600 allows two or more team members to participate in a collaborative session. As previously indicated, the synchronous collaboration component 600 expands the functions of the asynchronous collaboration component 500 of FIG. 5 with the addition of a sound board 900. Generally, the sound board 900 makes actions by one team member visible to another team member, whether in real-time or in a playback mode. In this manner, the synchronous collaboration component 600 supports virtual meetings among team members.

As shown in FIG. 6, the sound board 900 is a software entity comprised of the active client agents 510 associated with each team member. It is noted that in a synchronous collaboration mode one or more team members may be active at a time. The sound board 900 intercepts an incremental change (addition or modification) to the base document along a path 670 from the role and right filter 520 to the active client agent 510 of one team member and broadcasts such intercepted traffic to all other active client agents 510 of other active team members (and also records such intercepted traffic in the addendum database 420). Thus, all the team members in a synchronous session will share changes to the documents by sharing addendum additions in real time. The manner in which the sound board 900 serializes the various modification requests made by each team member and ensures that each team member is presented with a consistent view of the shared document is discussed further below in conjunction with FIG. 9.

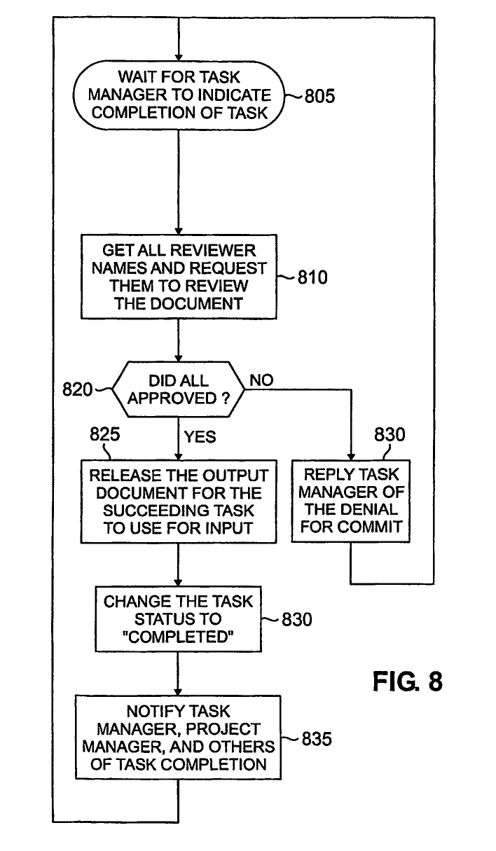

FIG. 7 is a flow chart showing transitions between an asynchronous collaboration mode 500 and a synchronous collaboration mode 600 (or vice versa) in accordance with the present invention. The transition process 700 is initiated during step 705 and remains in step 705 until a new session is started by a team member. From step 705, a team member can either start a new project or continue an existing project.

From step 705, a team member can start a new project in an asynchronous session as a manager of the project by following the execution path of steps 705, 707, 710 and 730. Likewise, a team member can continue an existing project in an asynchronous session by following the execution path of steps 505, 515, 525 and 530.

From step 705, a team member can start a new project in a synchronous collaboration session with somebody by following the execution path of steps 705, 707, 711, 735, 750, 760 and 765. Likewise, a team member can continue an existing project in a synchronous mode by following the execution path of steps 705, 715, 725, 735, 750, 760 and 765.

A team member can initiate a transition between asynchronous and synchronous modes by inviting another team member to an active session by following the execution path of steps 740, 750, 760 and 765. Similarly, the invitee either follows the execution path of steps 705, 720, 735, 750, 760 and 765; or the execution path 740, 750, 760 and 765.

In one preferred embodiment, when a team member goes into a synchronous session, the team member will always go through an asynchronous session at step 740 or an asynchronous session sign-in process at step 735. This allows the team member to obtain all the up-to-date document information from the addendum database 420. Once the document has been properly updated in accordance with the modifications from the addendum database 420, the status moves into a synchronous session at step 765.

From a synchronous collaboration session at step 765, a team member transition to an asynchronous collaboration session via the execution path 765, 775 and 740 or can go back to a no session status via the execution path 765, 770, 745 and 705. Thus, according to one aspect of the present invention, the components for synchronous collaboration are blended with components for asynchronous collaboration.

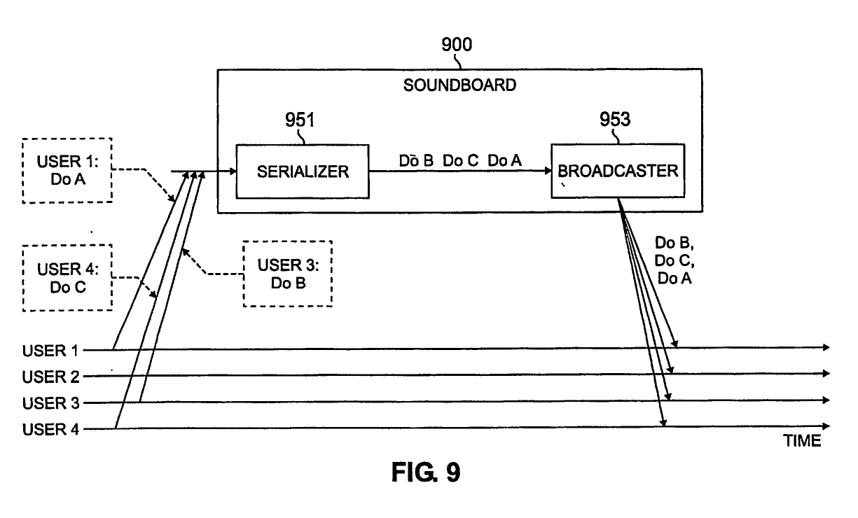

FIG. 8 is a flow chart illustrating an exemplary implementation of a task completion process 800 incorporating features of the present invention. As shown in FIG. 8, the task completion process 800 is initiated during step 805 when the task manager has indicated that a given task 150 is complete. As previously indicated, a succeeding task becomes active when the preceding task is completed. When the task manager of a given task 150 thinks the required output document(s) 140 are complete, the task manager can initiate the task completion process, for example, by issuing a “commit output document” command. As shown in FIG. 8, once the task manager issues a “commit output document” command, detected in step 805, the reviewers defined for the task are retrieved from the task property list 300 during step 810 and asked to perform a document review. When all the reviewers have approved the output document(s) during step 820, the approval will change the status of the output document 140, and the output document 140 will be copied to become the input document 110 for the next task, if appropriate, during step 825. The status of the task is changed to “complete” during step 830, and the appropriate individuals are notified of the task completion during step 835.

FIG. 9 illustrates the operation of the sound board 900 of FIG. 6 in further detail. As shown in FIG. 9, the sound board 900 consists of a serializer 951 and a broadcaster 953. In accordance with one aspect of the present invention, each user can submit conflicting change requests for an object spontaneously and concurrently. For example, a first user might request that an object is moved to the left while another user might request that the same object is moved to the right. The serializer 951 receives each of the change requests and serializes them, for example, based on an arrival time or a global clock. Serialized requests are then sent to the broadcaster 953 which broadcasts the requests to all users. As discussed above, the change requests can be broadcast to all currently active users in real-time, and can be stored in the addendum database 420 for subsequent access, e.g., by any late arriving users, as would be apparent to a person of ordinary skill in the art.

The operating system on the terminal of each user can manage the local user interface in a conventional manner and determine when the local user has requested a change to a shared document. When such a change is requested for a shared document, the operating system can relay the change request to the sound board 900. In one exemplary implementation, the initial change requests made by the local user to a shared document are not processed until the broadcast version of the change request is received back from the broadcaster 953. In a further variation, the initial change requests made by the local user to a shared document can be processed immediately and then discarded when the broadcast version of the change request is received back from the broadcaster 953. Other variations are possible, as would be apparent to a person of ordinary skill in the art based on the present disclosure.

In the example shown in FIG. 9, user 1, user 3, and user 4 send independent change requests to do A, do B, and do C, respectively. These requests are time ordered by the serializer 951 and sent to the broadcaster 953. The exemplary broadcaster 953 broadcasts the change requests based on the order of receipt to all subscribers including the originator of the change request. Thus, each user receives the same sequence of commands.

FIG. 10 is a flow chart illustrating an exemplary implementation of a conventional token-based document management system. As shown in FIG. 10, a first user (user 1), such as a member of a project team, desires to make a change to a shared object (step 1010). Thus, a request is made for the corresponding token(s) (step 1020). The token request is transmitted to a centralized document management system that administers the token. If the centralized document management system determines during step 1030 that the token is not available, the user receives an indication during step 1040 that the user must wait for the token to become available. If the centralized document management system determines during step 1030 that the token is available, then the user receives the token during step 1050.

Thereafter, user 1 is permitted to make any desired changes, and generates one or more command to modify the object associated with the token (step 1060). The command(s) to change the object are sent to the centralized document management system, and is detected during step 1064. The centralized document management system then broadcasts the change command(s) to each of the active users during step 1068. User 1 receives the broadcast change(s) during step 1070 and implements such changes during step 1080. The token-based document management system continues to process such changes that are requested by a user in possession of the token.

As previously indicated, a user of the token-based document management system will experience a delay (step 1020) before a desired change can be initiated to a shared object. The user must wait until he or she has possession of the token. The token-based document management system is even more complicated in the case of structured tokens. For example, a white board could be a shared object. On the object, a red color pen, a black color pen and an eraser can be used as tools to make changes. In such cases, one shared object can be changed in different ways. Thus, just to prepare one token for the entire white board is insufficient. It is noted that a red color pen and a black pen will not conflict to use at the same time by different users however a pen and an eraser might not be used at the same time. (since there is no consensus as to whether the pen or eraser is stronger if they work on the same spot). This requires the use of a structured token prohibiting pens and erasers to be used simultaneously, while the token should allow the use of different pens simultaneously. This makes the token-based implementation and design even more difficult. Another example of the use of structured tokens is in a spread sheet application, such as Microsoft Excel, where different tokens may be associated, for example, with each cell, row and column of a spreadsheet.

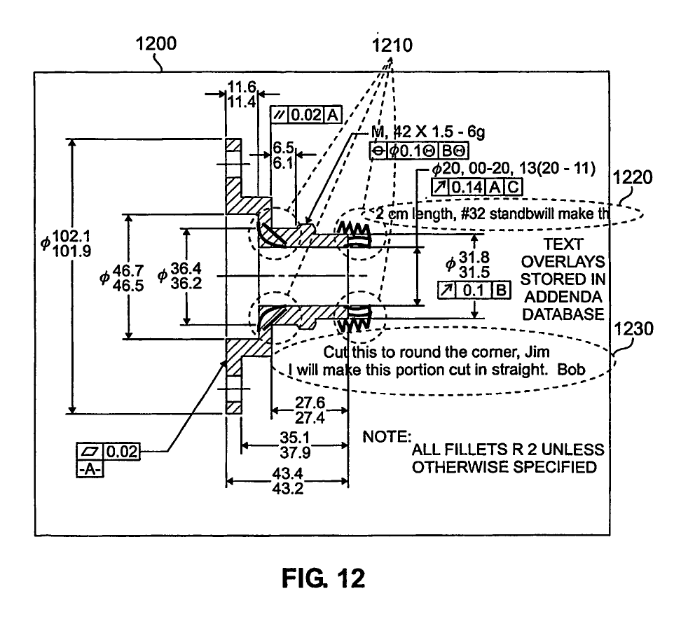

FIG. 11 is a flow chart illustrating an exemplary implementation of a shared document revision process incorporating features of the present invention. As shown in FIG. 11, a first user (user 1), such as a member of a project team, desires to make a change to a shared object (step 1110). With the present invention, the user can immediately make any desired changes, and generate one or more command to modify the object associated with the token (step 1120).

The command(s) to change the object are sent to the sound board 900, and is detected during step 1130. The sound board 900 then broadcasts the change command(s) to each of the active users during step 1140. User 1 receives the broadcast change(s) during step 1150 and implements such changes during step 1160.

It is noted that a single sound board 900 can handle multiple objects. In addition, the present invention allows each user to have a local copy of shared objects 1170 (unlike token based system). Generally, the present invention allows users to send commands to manipulate objects. These commands are serialized and distributed by the sound board 900 using a broadcast mechanism. This allows each user to keep a local copy of the shared object and to manipulate the shared object locally.

In the exemplary implementation, even the action creator (user 1 in FIG. 11) will receive the command via the sound board 900 almost at the same time as all of the other users. Thus, changes on the screen caused by the command will happen at about the same time for all users.

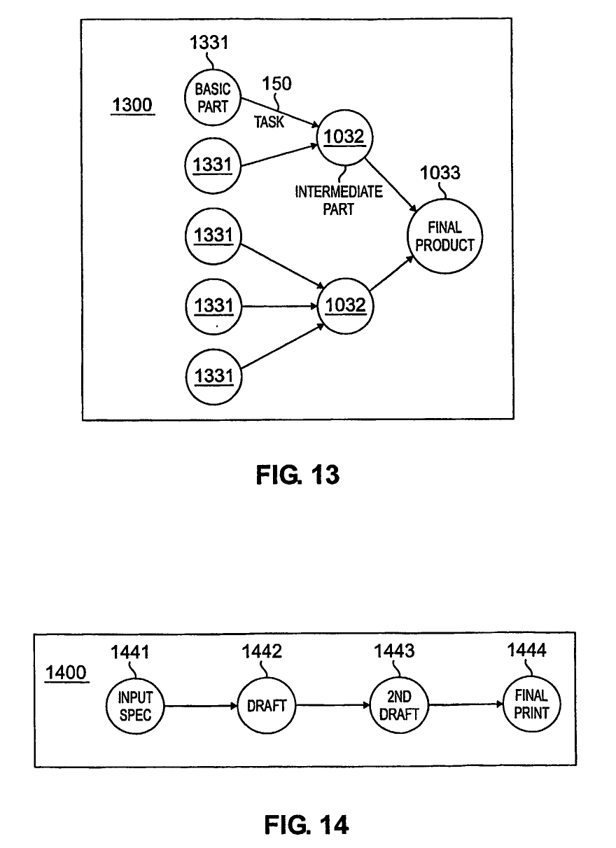

FIG. 12 illustrates a document 1200 that has been modified in accordance with the present invention. As shown in FIG. 12, the document 1200 is comprised of a base document and a number of overlays 1210, 1220 comprising additions or modifications to the base document. The overlays 1210, 1220 are each stored as separate events in the addendum database 420. As previously indicated, when a given document is requested, the active client agent 510 associated with the requesting team member accesses the input document in the document database 175 and any corresponding modifications 1210, 1220, 1230 contained in the addendum database 420 for delivery to the client software 480 on the client terminal 470 of the requesting team member.

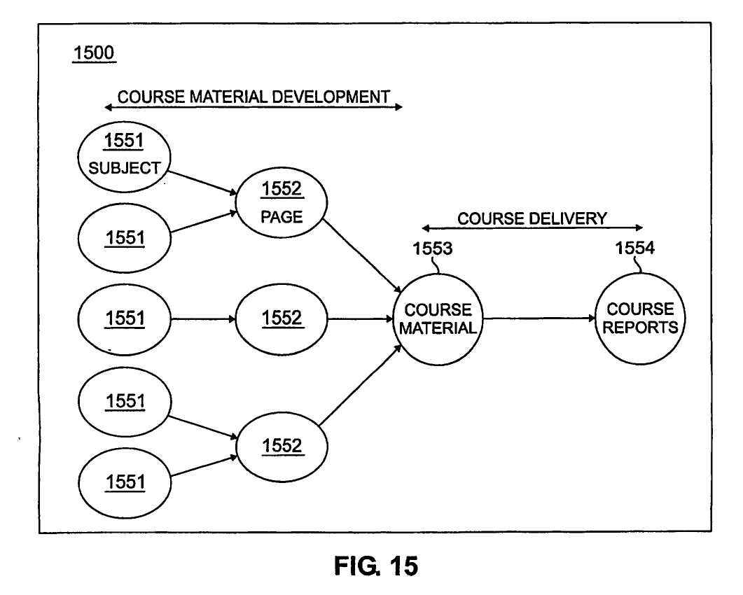

FIG. 13 illustrates an application of the present invention in a manufacturing environment. In the example of FIG. 13, the “input documents” comprise constituent basic parts 1331 that may be used to generate intermediate parts 1332 and a final product 1333. Each arc connecting the input, intermediate and output parts 1331, 1332, 1333 in FIG. 13 are tasks.

FIG. 14 illustrates an application of the present invention in a publishing environment. As shown in FIG. 14, the input documents 140 comprise an input specification document 1441, that are modified to generate one or more intermediate drafts 1442, 1443 before the final print 1444 is generated.

FIG. 15 illustrates an application of the present invention in an education and presentation environment. As shown in FIG. 15, the input documents 110 comprise materials 1551 covering a small subject area, intermediate documents 1552 for larger portions and then the course material 1553 for an entire course is generated. An instructor can use the course material 1553 to generate one or more course reports 1554.

It is to be understood that the embodiments and variations shown and described herein are merely illustrative of the principles of this invention and that various modifications may be implemented by those skilled in the art without departing from the scope and spirit of the invention.

I claim:

1. A network collaboration system, comprising:
one or more input documents;
one or more network connections that receive contributions to the input documents from one or more clients, wherein the contributions combined with the respective input document creates one or more output documents; and
a collaboration process that permits one or more of the clients to switch between a synchronous and an asynchronous collaboration session.

2. The system of claim 1, wherein the switching occurs when one of the clients in an asynchronous collaboration session invites one or more new clients to a synchronous collaboration session.

3. The system of claim 1, wherein the switching occurs when two or more of the clients coordinate to start a synchronous collaboration.

4. The system of claim 1, wherein one or more of the clients resume a suspended synchronous collaboration.

5. The system of claim 1, wherein the switching occurs when all of said clients leave the session.

6. The system of claim 1, wherein the switching occurs when all of said clients switch the session to an asynchronous session

7. The system of claim 1, wherein the collaboration process provides a synchronous collaboration component as an incremental addition to an asynchronous collaboration component.

8. The system of claim 7, where the incremental addition intercepts a contribution event from a client and broadcasts the intercepted contribution events to other clients.

9. The system of claim 1, wherein the collaboration process implements the contributions to the input documents based on a time of arrival.

10. The system of claim 1, wherein the collaboration process implements the contributions to the input documents based on a global time stamp.

11. The system of claim 1, wherein the collaboration process provides a consistent view of said one or more documents to each of said clients.

12. The system of claim 1, wherein the collaboration process broadcasts the contributions to the input documents to each of said clients.

13. The system of claim 1, where the contributions comprise at least one of a comment, a change request and an incremental modification of a document.

14. A method comprising the steps of:
receiving contributions to one or more input documents from one or more clients over a network;
combining the contributions with the respective input documents to create one or more output documents; and
switching one or more of the clients between a synchronous and an asynchronous collaboration session to make said contributions to one or more input documents.

15. The method of claim 14, wherein the switching step occurs when one of the clients in an asynchronous collaboration session invites one or more new clients to a synchronous collaboration session.

16. The method of claim 14, wherein the switching step occurs when two or more of the clients coordinate to start a synchronous collaboration.

17. The method of claim 14, wherein one or more of the clients resume a suspended synchronous collaboration.

18. The method of claim 14, wherein the switching step occurs when all of said clients leave the session.

19. The method of claim 14, wherein the switching step occurs when all of said clients switch the session to an asynchronous session

20. The method of claim 14, wherein the switching step selectively introduces a synchronous collaboration component as an incremental addition to an asynchronous collaboration component.

21. The method of claim 20, where the incremental addition intercepts a contribution event from a client and broadcasts the intercepted contribution events to other clients.

22. The method of claim 21, wherein the contribution events are processed based on a time of arrival.

23. The method of claim 21, wherein the contribution events are processed based on a global time stamp.

24. The method of claim 14, further comprising the step of presenting a consistent view of said one or more documents to each of said clients.

25. The method of claim 14, further comprising the step of broadcasting the contributions to the input documents to each of said clients.

26. A document management system, comprising:
one or more input documents;
one or more network connections that receive contributions to the input documents from a plurality of clients, each of said contributions have an associated time;
a serializer for ordering said contributions based on said associated time; and
a broadcaster for broadcasting said contributions to each of said plurality of clients.

27. The document management system of claim 26, wherein said associated time is an arrival time.

28. The document management system of claim 26, wherein said associated time is a global time stamp.

29. The document management system of claim 26, wherein said contributions are stored in an addendum database.

30. The document management system of claim 26, wherein each client has a local copy of at least said one of said documents.

31. The document management system of claim 26, wherein a contribution made by a given client is not processed until a broadcast version of the contribution is received.

32. The document management system of claim 26, wherein a contribution made by a given client is processed immediately and a broadcast version of the contribution is discarded.

33. The document management system of claim 26, wherein each client implements each contribution that is received from said broadcaster.

34. A method, comprising the steps of:
receiving contributions to one or more documents from a plurality of clients, each of said contributions have an associated time;
ordering said contributions based on said associated time; and
broadcasting said contributions to each of said plurality of clients.

35. The method of claim 34, wherein said associated time is an arrival time.

36. The method of claim 34, wherein said associated time is a global time stamp.

37. The method of claim 34, further comprising the step of storing said contributions in an addendum database.

38. The method of claim 34, wherein each client has a local copy of at least said one of said documents.

39. The method of claim 34, wherein a contribution made by a given client is not processed until a broadcast version of the contribution is received.

40. The method of claim 34, wherein a contribution made by a given client is processed immediately and a broadcast version of the contribution is discarded.

41. The method of claim 34, wherein each client implements each contribution that is received from said broadcaster.
